(19) United States
(12) Patent Application Publication
(10) Pub. No.: US 2015/0088565 A1
(43) Pub. Date: Mar. 26, 2015

(54) METHOD AND SYSTEM FOR LOGISTIC MANAGING AND STORAGE MEDIA WITH LOGISTIC MANAGING FUNCTION

(71) Applicants: HONG FU JIN PRECISION INDUSTRY (ShenZhen) CO., LTD, Shenzhen (CN); HON HAI PRECISION INDUSTRY CO., LTD., New Taipei (TW)

(72) Inventors: KUNG-CHIEH CHENG, New Taipei (TW); FU-QIANG HE, Shenzhen (CN)

(21) Appl. No.: 14/494,855

(22) Filed: Sep. 24, 2014

(30) Foreign Application Priority Data
Sep. 24, 2013 (CN) 201310437309.2

(51) Int. Cl. G06Q 10/08; G06Q 10/06

(52) U.S. Cl. CPC G06Q 10/08; G06Q 10/0631
USPC 705/7.12

(57) ABSTRACT

In a logistic managing system of a sever connectable with an ERP, includes a storage stores at least one logistic price; a first obtaining module obtains information of a shipment according to a manual operation; an analysis module generates a logistic expense sheet according to the logistic price and the information of the shipment; a recording module records the logistic expense sheet into the ERP.

### CROSS-REFERENCE TO RELATED APPLICATIONS

This application claims priority to Chinese Patent Application No. 201310437309.2 filed on Sep. 24, 2013, in the China Intellectual Property Office, the contents of which are incorporated by reference herein.

### FIELD

The present disclosure relates to a method and system for logistic managing and storage media with logistic managing function.

### BACKGROUND

Logistics management is crucial for many corporations, especially the management of logistics expenses. Thus an efficient logistic expense is required.

### BRIEF DESCRIPTION OF THE DRAWINGS

Implementations of the present disclosure will now be described, by way of example only, with reference to the attached figures, wherein:

FIG. 1 is a diagrammatic view of a server connecting with an ERP and a plurality of client computers.

FIG. 2 is a block diagram of one embodiment of function module of a logistic managing system.

FIG. 3 is a flowchart of one embodiment of a method for managing logistic data.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

In general, the word “module,” as used herein, refers to logic embodied in hardware or firmware, or to a collection of software commands, written in a programming language, for example, Java, C, or assembly. One or more software commands in the modules may be embedded in firmware, such as in an EPROM. Modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage system. Embodiments of the present disclosure will be described with reference to the drawings

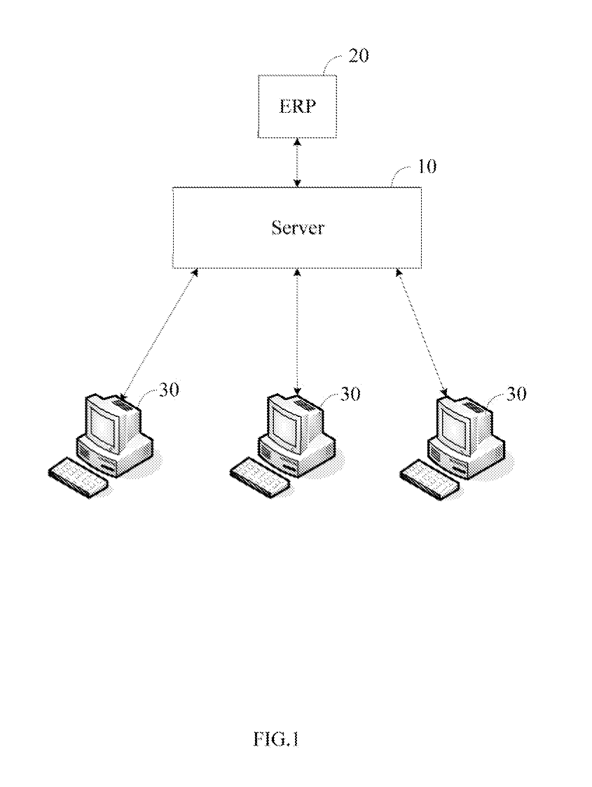

FIG. 1 is a diagrammatic view of a serve 10 communicating with a plurality of client computers 30 and an Enterprise Resource Planning (ERP) 20. In one embodiment, the server 10 is connected to the client computers 30 through a network. The ERP 20 is configured to record logistic data. In one embodiment, the ERP 20 can be installed in a remote computer (not shown in FIGS) or in the server 100.

The client computer 30 further includes an inputting device (not shown in the Figs). The inputting device may be a mouse or a keyboard for data input.

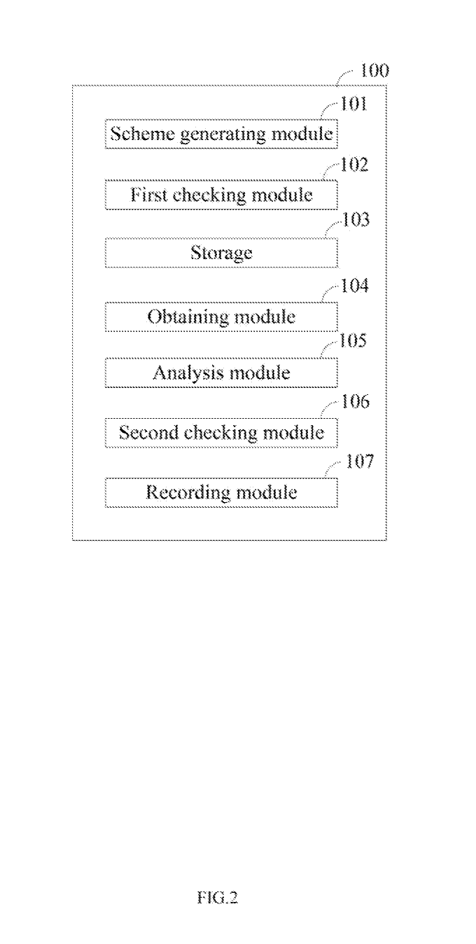

FIG. 2 is a block diagram of one embodiment of the function module of a logistic managing system 100 installed in the server 10. In one embodiment, the logistic managing system 100 includes a first receiving module 101, a first checking module 102, a storage 103, an obtaining module 104, an analyzing module 105, a second checking module 106, and a recording module 107.

The scheme generating module 101 receives logistic quotations according to a manual operation. In one embodiment, the logistic quotations can be inputted by one or more forwarder through the inputting device of the client computer 30. The logistic quotation includes a list of starting places and freight unit prices. The scheme generating module 101 further generates a logistic quote scheme according to the received logistic quotation. Thus, the logistic quote scheme includes one or more logistic quotation, and each logistic quotation includes the list of the starting places and freight unit prices.

The first checking module 102 checks the logistic quote scheme for approving the logistic quotation. In one embodiment, the first checking module 102 checks the logistic quote scheme by sending it to an approver through E-mail. When at least one logistic quotation of the logistic quote scheme is approved by the approver, the first checking module 102 stores the approved logistic quotation as the logistic price into the storage 103. When the logistic quote scheme is rejected by the approver, the first checking module 102 generates a first reject message for indicating the forwarder that the approver is rejected the logistic quote scheme.

The first obtaining module 104 obtains information of a shipment according to a manual operation, the information of the shipment comprising a starting place and a mileage of the shipment. In one embodiment, the information of the shipment can be inputted by a freight forwarder through the client computer. In other embodiment, the information of the shipment can be obtained from a database.

The analysis module 105 generates a logistic expense sheet in a first predetermined format according to the logistic price and the information of the shipment. Thus, the starting place, the mileage and the expense of the shipment can be recorded in the logistic expense sheet.

The second checking module 106 checks the logistic expense sheet for approving the logistic expense. In one embodiment, the second checking module 106 checks the logistic expense sheet by sending it to the approver through E-mail.

When the approver approves the logistic expense sheet, the second checking module 106 generates a recording signal. When the approver rejects the logistic expense sheet, the first checking module 102 generates a second reject message for indicating the forwarder that the approver is rejected the logistic expense sheet.

The recording module 107 records the logistic expense sheet into the ERP 20 in response to the recording signal.

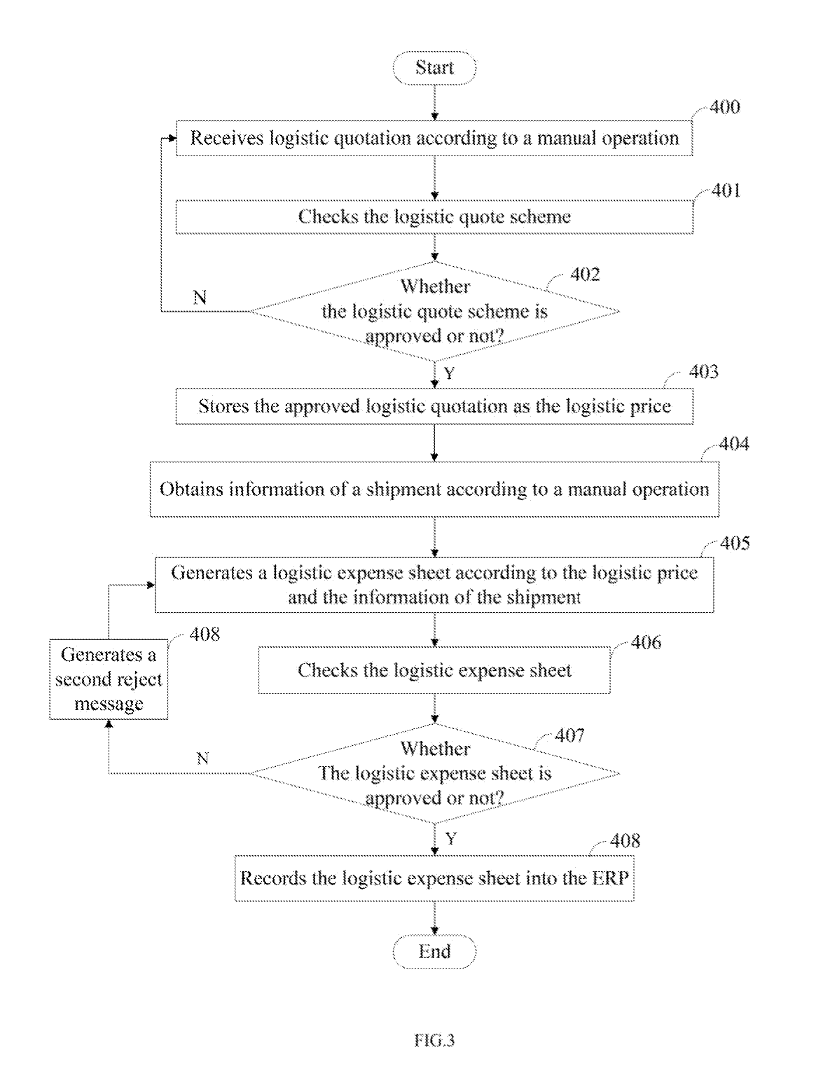

FIG. 3 illustrates a logistic managing method implemented by a server which is connectable with an ERP and a plurality client computer, for managing logistic data. The server includes a scheme generating module, a first checking module, a storage, an obtaining module, an analysis module, a second checking module and a recording module. Depending on the embodiment, additional steps may be added, others removed, and the ordering of the steps may be changed.

In block 400, the scheme generating module receives logistic quotation according to a manual operation. In one embodiment, the logistic quotations can be inputted by one or more forwarder through the inputting device of the client computer. The logistic quotation includes the list of the starting places and freight unit prices. The scheme generating module further generates a logistic quote scheme according to the received logistic quotation. Thus, the logistic quote scheme includes one or more logistic quotation, and each logistic quotation includes the list of the starting places and freight unit prices.

In block 401, the first checking module checks the logistic quote scheme for approving the logistic quotation. In one embodiment, the first checking module checks the logistic quote scheme by sending it to an approver through E-mail.

In block 402, the first checking module determines whether the logistic quote scheme is approved or not. When the approver approves at least one logistic quotation of the logistic quote scheme, the block 401 is implemented. When the approver rejects the logistic quote scheme, the first checking module generates a first reject message for indicating the forwarder that the approver is rejected the logistic quote scheme, and the block 400 is implemented.

In block 403, the first checking module stores the approved logistic quotation as the logistic price in the storage. The logistic price includes the list of the starting places and freight unit prices.

In block 404, the obtaining module obtains information of a shipment according to a manual operation, the information of the shipment comprising a starting place and a mileage of the shipment. In one embodiment, the information of the shipment can be inputted by a freight forwarder through the client computer. In other embodiment, the information of the shipment can be obtained from a database.

In block 405, the analysis module generates a logistic expense sheet in a first predetermined format according to the logistic price and the information of the shipment. Thus, the starting place, the mileage and the expense of the shipment can be recorded in the logistic expense sheet.

In block 406, the analysis module checks the logistic expense sheet for approving the logistic expense. In one embodiment, the second checking module 106 checks the logistic expense sheet by sending it to the approver through E-mail.

In block 407, the analysis module determines whether the logistic expense sheet is approved or not. When the logistic expense sheet is rejected by the approver, the block 408 is implemented. When the logistic expense sheet is approved by the approver, the block 409 is implemented.

In block 408, the first checking module generates a second reject message for indicating the forwarder that the approver is rejected the logistic expense sheet.

In block 409, the recording module records the logistic expense sheet into the ERP.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims.

What is claimed is:

1. A logistic managing system of a sever communicating with an Enterprise Resource Planning (ERP), the logistic managing system comprising
a storage configured to store at least one logistic price;
a processor; and
one or more programs stored in the storage and executed by the processor, the one or more programs comprising:
a first obtaining module configured to obtain information of a shipment according to a manual operation, the information of the shipment comprising a starting place and a mileage of the shipment;
an analysis module configured to generate a logistic expense sheet according to the logistic prices and the information of the shipment;
a recording module configured to record the logistic expense sheet into the ERP.

2. The logistic managing system as claimed in claim 1, wherein the one or more programs further comprising:
a scheme generating module configured to receive logistic quotation according to a manual operation and to generate a logistic quote scheme according to the received logistic quotation;
a first checking module configured to check the logistic quote scheme for approving the logistic quotation;
when one logistic quotation of the logistic quote scheme is approved, the first checking module further configured to store the approved logistic quotation as the logistic price.

3. The logistic managing system as claimed in claim 2, wherein the first checking module checks the logistic quote scheme by sending the logistic quote scheme to an approver and approving the approved logistic quotation according to a manual operation.

4. The logistic managing system as claimed in claim 1, wherein the one or more programs further comprising:
a second checking module configured to check the logistic expense sheet for approving the logistic expense;
when the logistic expense sheet is approved, the recording module configured to record the logistic expense sheet into the ERP.

5. The logistic managing system as claimed in claim 4, wherein the second checking module configured to check the logistic expense sheet by sending the logistic expense sheet to the approver and approving the logistic expense sheet according to a manual operation.

6. A logistic managing method for a logistic managing system of a server communicating with an ERP, the server comprising at least one hardware processor, the logistic managing method is capable of executed by a processor to perform instructions stored in a storage of the server, the server comprising one or more programs; the logistic managing method comprising:
providing at least one logistic price;
obtaining an information of a shipment according to a manual operation, the information of the shipment comprising a starting place and a mileage of the shipment;
generating a logistic expense sheet according to the logistic price and the information of the shipment;
recording the logistic expense sheet into the ERP.

7. The logistic managing method as claimed in claim 6, further comprising:
generating a logistic quote scheme comprising a plurality of logistic quotations;
checking the logistic quote scheme for approving the logistic quotation;
when one logistic quotation is approved, storing the approved logistic quotation.

8. The logistic managing method as claimed in claim 7, wherein the checking the logistic quote scheme comprising sending the logistic quote scheme to an approver and approving the approved logistic quotation according to a manual operation.

9. The logistic managing method as claimed in claim 6, further comprising:
checking the logistic expense sheet for approving the logistic expense;
when the logistic expense sheet is approved, recording the logistic expense sheet into the ERP.

10. The logistic managing method as claimed in claim 9, wherein the checking the logistic expense sheet comprising sending the logistic expense sheet to the approver and approving the logistic expense sheet according to a manual operation.

11. A non-transitory storage medium storing a plurality of modules, the plurality of modules comprising instructions executable by a processor of a device to perform a logistic managing method for processing logistic data, the logistic managing method comprising:
providing at least one logistic price;
obtaining an information of a shipment according to a manual operation, the information of the shipment comprising a starting place and a mileage of the shipment;
generating a logistic expense sheet according to the logistic price and the information of the shipment;
recording the logistic expense sheet into the ERP.

12. The non-transitory storage medium as claimed in claim 11, wherein the logistic managing method further comprising:
generating a logistic quote scheme comprising a plurality of logistic quotations;
checking the logistic quote scheme for approving the logistic quotation;
when one logistic quotation is approved, storing the approved logistic quotation.

13. The non-transitory storage medium as claimed in claim 12, wherein the checking the logistic quote scheme comprising sending the logistic quote scheme to an approver and approving the approved logistic quotation according to a manual operation.

14. The non-transitory storage medium as claimed in claim 11, wherein the logistic managing method further comprising:
checking the logistic expense sheet according to for approving the logistic expense;
when the logistic expense sheet is approved, recording the logistic expense sheet into the ERP.

15. The non-transitory storage medium as claimed in claim 14, wherein the checking the logistic expense sheet comprising sending the logistic expense sheet to the approver and approving the logistic expense sheet according to a manual operation.
